(19) United States
(12) Patent Application Publication
(10) Pub. No.: US 2021/0347047 A1
(43) Pub. Date: Nov. 11, 2021

(54) GENERATING ROBOT TRAJECTORIES USING NEURAL NETWORKS

(71) Applicant: X Development LLC, Mountain View, CA (US)

(72) Inventors: Maryam Bandari, Mountain View, CA (US); Kuangye Chen, Beijing (CN)

(21) Appl. No.: 16/867,437

(22) Filed: May 5, 2020

(51) Int. Cl. B25J 9/16; G05B 13/02; G06N 3/04

(52) U.S. Cl. CPC B25J 9/1664; B25J 9/163; G06N 3/0445; G05B 13/027

(57) ABSTRACT

Methods, systems, and apparatus, including computer programs encoded on computer storage media, for generating a trajectory of a robot. One of the methods includes receiving a plurality of path points; processing each network input in an input sequence that is derived from the path points using a trajectory generation neural network to generate an output sequence comprising a plurality of network outputs, each network output specifying a respective displacement between two adjacent trajectory points; and generating, based on the output sequence, a predicted trajectory of the robot.

### BACKGROUND

This specification relates to generating robot trajectories using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step.

An example of a recurrent neural network is a Long Short-Term Memory (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

Robot trajectory planning refers to generating plans for controlling a movement of a robot from an initial pose to a desired final pose, including traversing a plurality of intermediate poses. As such, generating robot trajectories typically involves generating a plurality of trajectory points that each correspond to a desired robot pose at a particular time step.

### SUMMARY

This specification describes how a system implemented as computer programs on one or more computers in one or more locations can generate robot trajectories using a neural network system. The neural network system can receive a system input that includes data specifying a robot path and process the system input to generate a system output that specifies a robot trajectory. The robot trajectory is typically parameterized by time and defines how a robot can travel through the robot path specified by the system input.

Particular embodiments of the subject matter described in this specification can be implemented so as to realize one or more of the following advantages.

Because of the adaptive nature of neural networks, the neural network system can be efficiently adapted to emulate any desired trajectory behavior. The neural network system thus can generate high quality trajectories, e.g., trajectories with desired temporal or spatial precisions, for various types of robots and from different input robot paths. Trajectories generated by the neural network system are generally more stable, e.g., when compared with trajectories generated by closed trajectory generators such as a robot controller simulation (RCS) model which might generate different trajectories for substantially the same input paths.

In addition, unlike closed trajectory generators which typically operate in form of a black box on very few dedicated platforms, the neural network system is more flexible, thus being suitable for deployment in many robotic development pipelines involving a range of hardware or software platforms. Generating trajectories using the neural network system is thus more resource-efficient, because doing so can save the substantial amount of computational resources, wall-clock time, or both that is otherwise required for data communication between two or more different systems (e.g., a robotic development system and a server system hosting the closed trajectory generator) that are typically involved in planning robot trajectories. As such, the neural network system also facilitates rapid robotic cell planning by generating hundreds or thousands of alternative trajectories more quickly than other conventional approaches, including using the closed trajectory generator.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example trajectory generation system in relation to an example closed trajectory generator.

FIG. 2 is a flow diagram of an example process for generating robot trajectories.

FIG. 3A is an illustration of example network inputs and outputs.

FIG. 3B is an illustration of example adjustments to network outputs.

Like reference numbers and designations in the various drawings indicate like elements.

### DETAILED DESCRIPTION

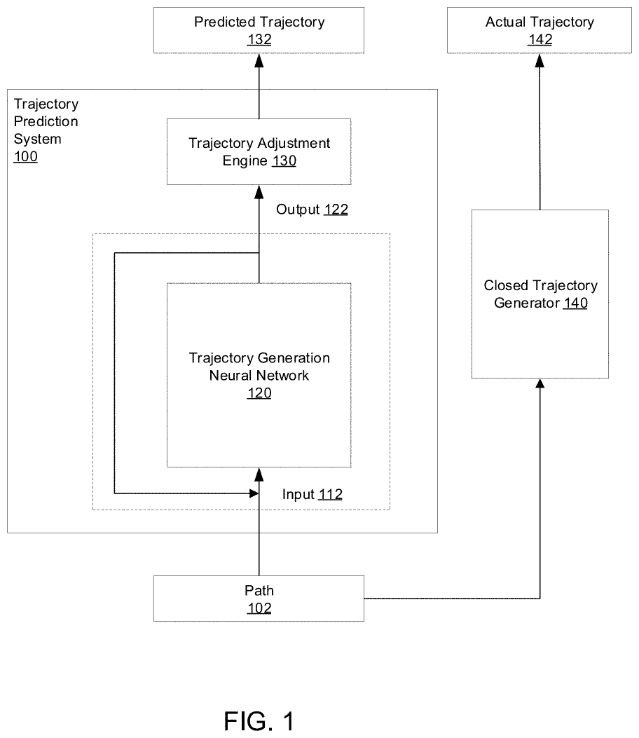

FIG. 1 shows an example trajectory prediction system 100 in relation to an example closed trajectory generator 140. The trajectory prediction system 100 is an example of a system implemented as computer programs on one or more computers in one or more locations, in which the systems, components, and techniques described below can be implemented.

The closed trajectory generator 140 is a software module or system that generates a trajectory from an input path. In this specification, closed trajectory generator is a trajectory generator whose behavior the trajectory prediction system 100 is attempting to emulate as closely as possible using machine learning techniques. In practice, the closed trajectory generator 140 can be closed in the sense that the entity operating the trajectory prediction system 100 does not have access to the source code or other documentation explaining how the trajectories are generated by the closed trajectory generator 140. However, any other appropriate trajectory generator that is or is not open to source code inspection can also be considered a “closed trajectory generator” when the trajectory prediction system 100 is trained to emulate its behavior.

The closed trajectory generator 140 can include a trajectory planner, e.g., a robot controller simulation (RCS) model or a B-Spline model. As one example, the RCS model can implement software that is configured to receive data specifying a given robot path 102 and generate one or more corresponding robot trajectories 142 (which are also referred to in this documentation as “actual trajectories”) defining how the robot should travel through the robot path 102.

In a typical situation, the closed trajectory generator 140 is used to generate the actual trajectory 142 to be executed by a robot at run-time. However, at path planning time, the closed trajectory generator 140 may prove to be problematic for a number of reasons. For example, the closed trajectory generator 140 may be far too slow in terms of wall clock time and generate results that are unstable or nondeterministic. In addition, it may not be possible in practice to parallelize the closed trajectory generator 140 to generate multiple candidate trajectories in parallel at path planning time. This can be because of software license issues or technical limitations. Thus, the closed trajectory generator 140 typically operates in a form of black box, hindering interpolations or adjustments from being applied to the trajectory planning process.

The path planning process can be greatly sped up by using the trajectory prediction system 100 instead of the closed trajectory generator 140. Unlike the closed trajectory generator 140, the trajectory prediction system 100 can be massively parallelized to generate trajectories for thousands or millions of candidate paths.

The trajectory prediction system 100 is a machine learning system that receives a system input specifying a robot path 102 and generates, from the robot path 102, a system output specifying a predicted robot trajectory 132. Referring to the trajectories generated by the system 100 as predicted trajectories indicates that the system 100 is specifically configured to generate predicted trajectories that imitate the actual trajectories generated by the closed trajectory generator 140.

For example, the system input includes data specifying a sequence of path points that each correspond to a particular pose of a robot, i.e., with reference to a predetermined coordinate frame. The path points can be defined, for example, in robot configuration space (i.e., joint space) or task space (i.e., Cartesian space). Collectively, the sequence of path points defines a geometric path for moving a robot from an initial pose to a desired final pose. The trajectory prediction system 100 can then determine, from the geometric path defined by the system input, the system output that includes a sequence of trajectory points. Collectively, the sequence of trajectory points, which are usually time-parameterized, define how the robot can travel through the geometric path. In other words, the system 100 can process the system input to generate the system output specifying what pose the robot should be in at each of a plurality of time steps.

A pose of the robot refers to an orientation, a position, or both of the robot with reference to the predetermined coordinate frame. In addition, poses can generally be defined using multi-dimensional structured data. The exact dimension of the structured data representing a pose is generally dependent on degrees of freedom (DoF) of the robot. For example, if the robot is a fixed-base robot with six revolute joints, then a particular pose of the robot can be defined using a 6-dimensional vector, with each element of the vector representing a respective joint angle, e.g., measured in radians.

In particular, the trajectory prediction system 100 includes a trajectory generation neural network 120 and, in some implementations, a trajectory adjustment engine 130. The trajectory generation neural network 120 may be a feedforward neural network or a recurrent neural network that is configured to receive a sequence of inputs 112 that each include information that is specified by or derived from the system input, and process the inputs 112 in accordance with current parameter values of the network 120 to generate, over multiple time steps, a sequence of network outputs 122 defining an initial predicted robot trajectory 132, which is also referred to in this document as a “forward trajectory”.

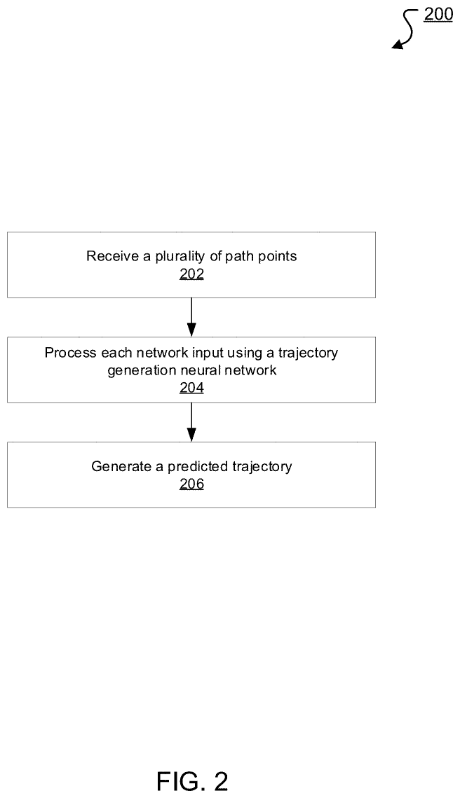

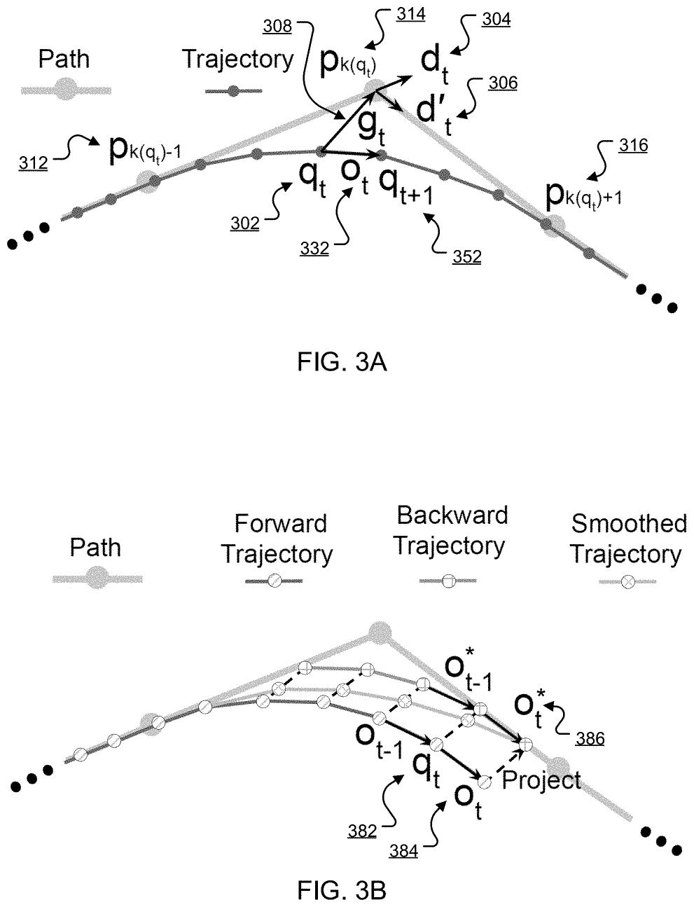

Briefly, at each of the multiple time steps, the trajectory prediction system 100 generates a current input 112 for the network 120 based on (i) the system input that specifies a robot path 102, (ii) previous inputs in the sequence of inputs 112, (iii) previous outputs generated by the network 120, or a combination of (i)-(iii). Generating the sequence of inputs 112 will be described in more detail below with reference to FIG. 2 and FIG. 3A.

Example recurrent neural networks include long-short term memory (LSTM) networks or gated recurrent unit (GRU) networks. That is, in some cases, the trajectory generation neural network 120 may be a recurrent neural network that includes one or more long-short term memory (LSTM) layers or gated recurrent unit (GRU) layers. Each layer in turn includes one or more memory cells. For example, each LSTM layer can include one or more memory cells that each include an input gate, a forget gate, and an output gate that allow the cell to store previous states for the cell, e.g., for use in generating a current activation or to be provided to other components of the LSTM neural network.

To generate the sequence of network outputs 122 that define a forward trajectory of the robot, at each of the multiple time steps, the trajectory generation neural network 120 generally receives as input (i) a current input 102 for the current time step and (ii) a preceding network output 122 that was generated by the network at the preceding time step, and generates a current output 122 for the current time step.

For convenience, the trajectory generation neural network 120 as used in throughout this document refers to a fully-learned neural network. A neural network is said to be “fully-learned” if the neural network has been trained to compute a desired prediction. In other words, a fully-learned neural network generates an output based solely on being trained on training data rather than on human-programmed decisions.

In some cases, the training data for use in training the network 120 can be derived from the actual trajectories that are generated by the closed trajectory generator 140 for multiple given robot paths. The given robot path can be any path for which corresponding robot trajectories need to be determined. The discrete trajectory points to be used in computing the target output that is associated with each training input can then be obtained by sampling the actual robot trajectories generated by the closed trajectory generator 140 at a fixed frequency, e.g., 10 Hz, 20 Hz, or 30 Hz. To obtain the fully-learned trajectory generation neural network 120, a training engine (not shown in the figure) can iteratively adjust current parameter values of the network 120 by optimizing an objective function that measures a difference between network outputs and target outputs that are derived from actual trajectories generated by closed trajectory generator 140, e.g., based on a computed gradient of the objective function and using a gradient descent optimization technique, e.g., an RMSprop or Adam technique.

The trajectory adjustment engine 130, when included, can then receive the network outputs 122 which collectively define the forward trajectory and generate an adjusted predicted trajectory 132 from the network outputs 122. The adjusted predicted robot trajectory 132 generated by the trajectory adjustment engine 130 is also referred to in this document as a “backward trajectory”.

Briefly, from each network output 122 generated by the trajectory generation neural network 120, the trajectory adjustment engine 130 determines whether to apply an adjustment to the forward trajectory point defined by the network output. The trajectory adjustment engine 130 then determines, from the adjustments to the forward trajectory generated by the neural network 120 for one or more of the sequence of inputs 102, the backward trajectory for the input path 102. Determining adjustments to the network outputs 122 will be described in more detail below with reference to FIG. 2 and FIG. 3B.

FIG. 2 is a flow diagram of an example process 200 for generating robot trajectories. For convenience, the process 300 will be described as being performed by a system of one or more computers located in one or more locations. For example, a trajectory generation system, e.g., the trajectory generation system 100 of FIG. 1, appropriately programmed in accordance with this specification, can perform the process 200.

The system receives a plurality of path points (202). For example, the plurality of path points can define a robot path for which one or more corresponding trajectories need to be determined.

The system processes each network input in an input sequence that is derived from the path points using a trajectory generation neural network to generate an output sequence that includes a plurality of network outputs (204). Because the trajectory generation neural network is configured to auto-regressively generate data specifying robot trajectories over multiple time steps, at each time step the system can instantaneously, i.e., in real-time, generate a current network input for the network based on (i) a received system input that specifies a sequence of path points that collectively define a robot path for which a trajectory needs to be determined, (ii) previous network inputs in the input sequence, (iii) previous network outputs generated by the network, or a combination of one or more of (i)-(iii).

FIG. 3A is an illustration of example network inputs and outputs. As depicted in FIG. 3A, a network input specifies a current trajectory point qₜ 302, a current reference direction dₜ 304 for the current trajectory point qₜ 302, a future reference direction d′ₜ 306 for the current trajectory point qₜ 302, and “goal” vector gₜ 308 for the current trajectory point qₜ 302.

Specifically, for each network input in the input sequence, the current trajectory point qₜ is the starting trajectory point from which the system predicts a subsequent movement of a robot. The system generally determines the current trajectory point qₜ from a preceding network output oₜ₋₁ and a preceding trajectory point qₜ₋₁. For the very first time step, because there is no preceding network output or preceding trajectory point, the system instead uses the first path point in the sequence of path points specified by the system input as the current trajectory point.

The system can obtain the current reference direction

$${d}_{t} = \frac{{p}_{k ( qt )} - {p}_{k ( qt ) - 1}}{‖ {p}_{k ( qt )} - {p}_{k ( qt ) - 1} ‖}$$

based on computing a displacement from the preceding path point p_{k(q}_{ₜ}₎₋₁ to the current path point p_{k(q}_{ₜ}₎ of the current trajectory point qₜ. In the example of FIG. 3A, for the current trajectory point qₜ 302, its current path point p_{k(q}_{ₜ}₎ 314 corresponds to the first path point that will be met starting from the current trajectory point qₜ, and its preceding path point p_{k(q}_{ₜ}₎₋₁ 312 corresponds to the immediately preceding path point of the current path point p_{k(q}_{ₜ}₎ 314 in the sequence of path points pₖ that define the robot path.

To determine which path point in the input sequence should be used as the current path point, the system can keep a record of respective distances between the generated trajectory points and the current path point. The system can then proceed to use a subsequent path point in the input sequence as the current path point when the distance begins to increase.

The system can obtain the future reference direction

$${d}_{t}^{′} = \frac{{p}_{k ( qt ) + 1} - {p}_{k ( qt )}}{‖ {p}_{k ( qt ) + 1} - {p}_{k ( qt )} ‖}$$

based on computing a displacement from the current path point p_{k(q}_{ₜ}₎ to the subsequent path point p_{k(q}_{ₜ}₎₊₁ of the current trajectory point qₜ. In the example of FIG. 3A, for the current trajectory point qₜ 302, its subsequent path point p_{k(q}_{ₜ}₎₊₁ 316 corresponds to the immediately subsequent path point of the current path point p_{k(q}_{ₜ}₎ 314 in the sequence of path points pₖ that define the robot path.

The system can obtain the “goal” vector gₜ=p_{k(q}_{ₜ}₎−qₜ based on computing a displacement from the current trajectory point qₜ to the current path point p_{k(q}_{ₜ}₎ of the current trajectory point qₜ. In the example of FIG. 3A, for the current trajectory point qₜ 302, the system can obtain the “goal” vector gₜ 308 based computing a displacement from the current trajectory point qₜ 302 to the current path point p_{k(q}_{ₜ}₎ 314 of the current trajectory point qₜ 302.

Each network output in turn specifies a respective displacement between a current trajectory point and a subsequent trajectory point. As described above, the system generates the plurality of network outputs over multiple time steps.

In particular, at each time step, the system provides the trajectory generation neural network with (i) a current network input and (ii) a preceding network output and uses the network to generate a current network output that specifies a displacement between a current trajectory point and a subsequent trajectory point. For the very first time step, because there is no preceding network output, the system can instead provide the network with the current network input and a predetermined placeholder input, i.e., in place of the preceding network output. The trajectory generation neural network then processes the current input and the predetermined placeholder input to generate the current network output for the first time step.

In the example of FIG. 3A, the system uses the trajectory generation neural network to generate a current network output oₜ 332 which defines a displacement from the current trajectory point qₜ 302 to the subsequent trajectory point qₜ₊₁ 352. In other words, in this example, the system predicts qₜ₊₁ 352 to be the next trajectory point when generating the robot trajectory from the robot path.

The system generates a predicted trajectory of the robot (206) that is derived from the output sequence. For example, because each network output specifies a respective displacement between two adjacent trajectory points, the system can generate the predicted trajectory by computing a concatenation the respective displacements specified by the output sequence. The predicted trajectory in this way is also referred to as a forward trajectory of the robot.

Optionally, in some cases, the system can also generate a backward trajectory from the forward trajectory by determining adjustments to one or more of the network outputs included in the sequence.

Specifically, starting from the last network output in the output sequence, the system iteratively determines whether the displacement oₜ that is specified by the network output is parallel to the current reference direction dₜ of the current trajectory point qₜ as specified by the corresponding network input.

In response to a positive determination, i.e., upon determining that the displacement that is specified by the network output is parallel to the reference direction of the current trajectory point, the system determines an adjustment to the displacement based on two adjacent path points of the current trajectory point. In general, the system determines such adjustment to require that, when the displacement of the current trajectory point is parallel to its current reference direction, a robot should travel in a line connecting the preceding path point and the current path point.

FIG. 3B is an illustration of example adjustments to network outputs. As shown in FIG. 3B, the system determines that the displacement oₜ 384 of the current trajectory point qₜ 382 is parallel to its current reference direction dₜ. Accordingly, the system can apply an adjustment to move the displacement to oₜ* 386 by projecting the displacement oₜ 384 to a line connecting two adjacent path points of the current trajectory point, i.e., the line connecting the preceding path point p_{k(q}_{ₜ}₎₋₁ of the current trajectory point qₜ 382 and the current path point p_{k(q}_{ₜ}₎ of the current trajectory point qₜ 382.

From this network output, the system follows a backward iteration process to iteratively determine adjustments to respective displacements specified by preceding network outputs in the output sequence.

In various cases, in response to a negative determination, e.g., upon determining that the displacement that is specified by the network output is not parallel to the reference direction of the current trajectory point, the system generally moves onto a preceding network output in the output sequence without specifically applying any adjustments to the trajectory point.

Once this backward iteration process has completed, the system can generate the backward trajectory from the adjustments being applied to the output sequence that is generated by the trajectory generation neural network. In other words, the system can use the backward trajectory instead of or in addition to the forward trajectory for use in planning a movement of the robot to travel through the robot path that is defined by the system input.

Optionally, the system can also generate a “smoothed trajectory” by computing a weighted average of the forward trajectory and the backward trajectory. The smoothed trajectory, when generated, will then be similarly used in planning the movement of the robot. Examples of forward, backward, and smoothed trajectories are shown in FIG. 3B.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

In addition to the embodiments described above, the following embodiments are also innovative:

Embodiment 1 is a method comprising:

receiving a plurality of path points;

processing each network input of a plurality of network inputs in an input sequence that is derived from the path points using a trajectory generation neural network to generate an output sequence comprising a plurality of network outputs, each network output specifying a respective displacement between two adjacent trajectory points; and

generating, based on the output sequence, a predicted trajectory of the robot.

Embodiment 2 is the method of embodiment 1, wherein the predicted trajectory of the robot represents a prediction for an output trajectory of a closed trajectory generator when given the path points.

Embodiment 3 is the method of any one of embodiments 1-2, wherein each network input specifies (i) a position of a current trajectory point, (ii) a current reference direction of the current trajectory point, (iii) a future reference direction of the current trajectory point, and (iv) a goal vector measuring a displacement between the current trajectory point and a current path point.

Embodiment 4 is the method of any one of embodiments 1-3, further comprising generating an adjusted predicted trajectory from the predicted trajectory, comprising, for each network output in the output sequence:

determining whether the displacement that is specified by the network output is parallel to the reference direction of the current trajectory point; and

in response to a positive determination: determining, based on two adjacent path points of the current trajectory point, an adjustment to the displacement.

Embodiment 5 is the method of any one of embodiments 1-4, wherein:

the trajectory generation neural network is a recurrent neural network; and

generating the output sequence comprising the plurality of network outputs comprises, at each of a plurality of time steps: processing, using the trajectory generation neural network, a current network input and a preceding network output to generate a current network output.

Embodiment 6 is the method of any one of embodiments 4-5, wherein determining the adjustment to the displacement comprises: projecting the displacement to a line connecting two adjacent path points of the current trajectory point.

Embodiment 7 is the method of any one of embodiments 4-6, wherein determining the adjustment to the displacement further comprises: iteratively determining adjustments to respective displacements specified by preceding network outputs in the output sequence.

Embodiment 8 is the method of any one of embodiments 4-7, further comprising generating a smoothened predicted trajectory by computing a weighted average of the predicted trajectory and the adjusted predicted trajectory.

Embodiment 9 is the method of any one of embodiments 1-8, wherein each trajectory point or path point is represented by multi-dimensional data having a respective dimension that is dependent on degrees of freedom (DoF) of the robot.

Embodiment 10 is the method of any one of embodiments 1-9, further comprising training the trajectory generation neural network by optimizing an objective function measuring a difference between network outputs and target outputs that are derived from trajectories generated by Robot Controller Simulation (RCS).

Embodiment 11 is a system comprising: one or more computers and one or more storage devices storing instructions that are operable, when executed by the one or more computers, to cause the one or more computers to perform the method of any one of embodiments 1 to 10.

Embodiment 12 is a computer storage medium encoded with a computer program, the program comprising instructions that are operable, when executed by data processing apparatus, to cause the data processing apparatus to perform the method of any one of embodiments 1 to 10.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of generating a trajectory of a robot, the method comprising:
receiving a plurality of path points;
processing each network input of a plurality of network inputs in an input sequence that is derived from the path points using a trajectory generation neural network to generate an output sequence comprising a plurality of network outputs, each network output specifying a respective displacement between two adjacent trajectory points; and
generating, based on the output sequence, a predicted trajectory of the robot.

2. The method of claim 1, wherein the predicted trajectory of the robot represents a prediction for an output trajectory of a closed trajectory generator when given the path points.

3. The method of claim 1, wherein each network input specifies (i) a position of a current trajectory point, (ii) a current reference direction of the current trajectory point, (iii) a future reference direction of the current trajectory point, and (iv) a goal vector measuring a displacement between the current trajectory point and a current path point.

4. The method of claim 1, further comprising:
generating an adjusted predicted trajectory from the predicted trajectory, comprising, for each network output in the output sequence:
determining whether the displacement that is specified by the network output is parallel to the reference direction of the current trajectory point; and
in response to a positive determination:
determining, based on two adjacent path points of the current trajectory point, an adjustment to the displacement.

5. The method of claim 1, wherein:
the trajectory generation neural network is a recurrent neural network; and
generating the output sequence comprising the plurality of network outputs comprises, at each of a plurality of time steps:
processing, using the trajectory generation neural network, a current network input and a preceding network output to generate a current network output.

6. The method of claim 4, wherein determining the adjustment to the displacement comprises:
projecting the displacement to a line connecting two adjacent path points of the current trajectory point.

7. The method of claim 4, wherein determining the adjustment to the displacement further comprises:
iteratively determining adjustments to respective displacements specified by preceding network outputs in the output sequence.

8. The method of claim 4, further comprising:
generating a smoothened predicted trajectory by computing a weighted average of the predicted trajectory and the adjusted predicted trajectory.

9. The method of claim 1, wherein each trajectory point or path point is represented by multi-dimensional data having a respective dimension that is dependent on degrees of freedom (DoF) of the robot.

10. The method of claim 1, further comprising:
training the trajectory generation neural network by optimizing an objective function measuring a difference between network outputs and target outputs that are derived from trajectories generated by Robot Controller Simulation (RCS).

11. A system comprising one or more computers and one or more storage devices storing instructions that when executed by the one or more computers cause the one or more computers to perform operations for generating a trajectory of a robot, the operations comprising:
receiving a plurality of path points;
processing each network input of a plurality of network inputs in an input sequence that is derived from the path points using a trajectory generation neural network to generate an output sequence comprising a plurality of network outputs, each network output specifying a respective displacement between two adjacent trajectory points; and
generating, based on the output sequence, a predicted trajectory of the robot.

12. The system of claim 11, wherein each network input specifies (i) a position of a current trajectory point, (ii) a current reference direction of the current trajectory point, (iii) a future reference direction of the current trajectory point, and (iv) a goal vector measuring a displacement between the current trajectory point and a current path point.

13. The system of claim 11, wherein the operations further comprise:
generating an adjusted predicted trajectory from the predicted trajectory, comprising, for each network output in the output sequence:
determining whether the displacement that is specified by the network output is parallel to the reference direction of the current trajectory point; and
in response to a positive determination:
determining, based on two adjacent path points of the current trajectory point, an adjustment to the displacement.

14. The system of claim 11, wherein:
the trajectory generation neural network is a recurrent neural network; and
generating the output sequence comprising the plurality of network outputs comprises, at each of a plurality of time steps:
processing, using the trajectory generation neural network, a current network input and a preceding network output to generate a current network output.

15. The system of claim 13, wherein the operations further comprise:
generating a smoothened predicted trajectory by computing a weighted average of the predicted trajectory and the adjusted predicted trajectory.

16. One or more non-transitory computer-readable storage media storing instructions that when executed by one or more computers cause the one or more computers to perform operations for generating a trajectory of a robot, the operations comprising:
receiving a plurality of path points;
processing each network input of a plurality of network inputs in an input sequence that is derived from the path points using a trajectory generation neural network to generate an output sequence comprising a plurality of network outputs, each network output specifying a respective displacement between two adjacent trajectory points; and
generating, based on the output sequence, a predicted trajectory of the robot.

17. The non-transitory computer-readable storage media of claim 16, wherein each network input specifies (i) a position of a current trajectory point, (ii) a current reference direction of the current trajectory point, (iii) a future reference direction of the current trajectory point, and (iv) a goal vector measuring a displacement between the current trajectory point and a current path point.

18. The non-transitory computer-readable storage media of claim 16, wherein the operations further comprise:
generating an adjusted predicted trajectory from the predicted trajectory, comprising, for each network output in the output sequence:
determining whether the displacement that is specified by the network output is parallel to the reference direction of the current trajectory point; and
in response to a positive determination:
determining, based on two adjacent path points of the current trajectory point, an adjustment to the displacement.

19. The non-transitory computer-readable storage media of claim 16, wherein:
the trajectory generation neural network is a recurrent neural network; and
generating the output sequence comprising the plurality of network outputs comprises, at each of a plurality of time steps:
processing, using the trajectory generation neural network, a current network input and a preceding network output to generate a current network output.

20. The non-transitory computer-readable storage media of claim 16, wherein the operations further comprise:
generating a smoothened predicted trajectory by computing a weighted average of the predicted trajectory and the adjusted predicted trajectory.
